(19) United States
(12) Patent Application Publication
(10) Pub. No.: US 2022/0034704 A1
(43) Pub. Date: Feb. 3, 2022

(54) METHOD AND APPARATUS FOR DETERMINING A FILL LEVEL OF A FLUID IN A TANK

(71) Applicant: Robert Bosch GmbH, Stuttgart (DE)

(72) Inventors: Arthur Bastoreala, Remseck Am Neckar (DE); Jan Michl Hofmann, Ludwigsburg (DE); Sascha Rademann, Stuttgart (DE); Tania Gonzalez-Baquet, Ludwigsburg (DE); Tobias Pfister, Stuttgart (DE)

(21) Appl. No.: 17/387,098

(22) Filed: Jul. 28, 2021

(30) Foreign Application Priority Data
Jul. 29, 2020 (DE) 102020209575.2

(51) Int. Cl. G01F 23/296

(52) U.S. Cl. CPC G01F 23/2962

(57) ABSTRACT

A method and an apparatus for determining the fill level of a fluid (2) in a tank (1), wherein a propagation time of an ultrasonic signal between an ultrasound element (4) and a reflection at the surface (3) of the fluid (2) is measured. A first, single reflection and a second, double reflection are evaluated, wherein the measurement of the reflections is carried out with a measurement setting with an excitation energy of the ultrasonic signal and a sensitivity. The sensitivity is indicated by a gain and a comparison value (13). Via measurements with different measurement settings, a suspected first reflection and a suspected second reflection are located and a plausibility check is carried out of the propagation times of the first and second reflections with respect to each other.

### BACKGROUND OF THE INVENTION

The invention is based on a method and an apparatus for determining the fill level of a fluid in a tank according to the generic type of the independent claims. Methods and devices are already known in which a propagation time of an ultrasonic signal between an ultrasound element and a reflection at the surface of the fluid is measured. Both a single reflection as well as multiple reflections are evaluated. The measurement is carried out with a variable energy of the ultrasonic signal, variable gain, and a variable comparison value.

### SUMMARY OF THE INVENTION

By contrast, the method according to the invention and the apparatus according to the invention have the advantage that an improved method for determining the fill level is specified. In particular, the fill level can thus be determined with high precision in a particularly reliable manner. No changes to the sensor element and the evaluating electronics are necessary, apart from additional measuring steps with a modified measurement setting.

A particularly good evaluation of the measuring signals is obtained by means of a plausibility check of the first and second reflections with regard to their propagation time. Deviations from the expected propagation times and/or further reflections at unexpected times are suitable means for detecting incorrect measurements. If necessary, unexpected reflections can also be practically evaluated by reversing the roles of the first and second reflections. The further processing of the measurements is particularly simple if they are converted into digital signals. Alternatively, the digital signals can also be evaluated in such a way that a promising level of sensitivity is determined for the subsequent measurement. In addition, it may be the case that different sensitivities are evaluated simultaneously, which enables a particularly fast and accurate measurement. By reversing the sensitivities during a measurement, the precision of each individual measurement can be improved.

### BRIEF DESCRIPTION OF THE DRAWINGS

Exemplary embodiments of the inventions are shown in the drawings and explained in more detail in the following description.

In the drawings:

FIG. 1 shows the arrangement of an ultrasound element in a tank,

FIG. 2 shows a first measurement with a first sensitivity,

FIG. 3 shows a second measurement with a second sensitivity,

and FIG. 4 shows a third measurement with a third sensitivity.

### DETAILED DESCRIPTION

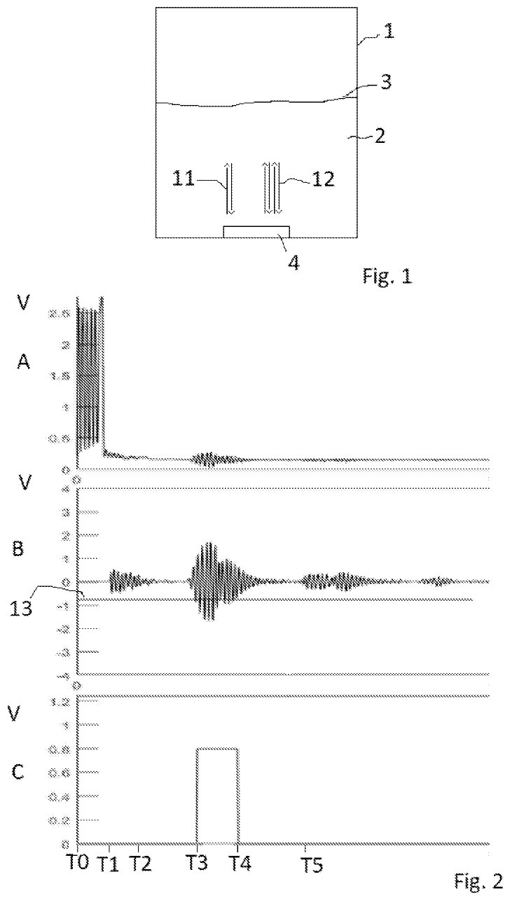

FIG. 1 shows a schematic drawing of a tank 1, in which a fluid 2 is arranged. At the bottom of the tank an ultrasound element 4 is arranged, for example a piezo element 4, which is used to introduce an ultrasonic signal into the fluid. Such an ultrasonic signal is a sound wave or acoustic signal, which moves through the fluid at the speed of sound and is reflected at the surface 3 of the fluid 2 in the tank 1. The acoustic signal reflected at the surface 3 then passes through the fluid 2 in the tank once again and strikes the ultrasound element 4 again. In the case of an ultrasound element 4 in the form of a piezo element, the sound wave reflected back can be detected by appropriate voltage signals. By measuring the propagation time between the excitation of the ultrasound in the piezo element 4 and the arrival of the reflected ultrasonic wave, the fill level of the tank 1 can be determined if the speed of sound in the fluid 3 is known.

In this situation the sound wave can travel back and forth multiple times in the fluid 2. FIG. 1 schematically shows a first reflection 11 at the surface 3 of the fluid 2, in which the sound wave travels from the piezo element 4 to the surface 3 once and from there is reflected back to the piezo element 4 again. In addition, a second, double reflection 12 is shown schematically in FIG. 1, in which the sound wave travels from the piezo element 4 to the surface 3 once and back again, and then travels from the piezo element 4 to the surface 3 and back a second time.

The ultrasonic signal is attenuated when passing through the fluids, so that under ideal conditions the second reflection 12 has a significantly lower intensity than the first reflection 11. However, since the surface 3 of the fluid 2 is continuously in motion due to movements of the tank 1, it may be the case that the attenuation or the intensities of the individual measurement cannot be uniquely assigned. Furthermore, the intensity of a single measurement also depends on the height of the fill level, the temperature, and possible flows of the fluid 2 in the tank 1. Furthermore, the angle at which the ultrasonic signal strikes the surface 3 of the fluid 2 has a large effect. This results from the angle of inclination of the tank toward the horizontal (tilted tank) and the rotation of the tank about the vertical axis in the case of a tilted tank. In order to deal with these numerous influencing factors on the measurement of the reflections, the measurement settings are therefore varied when measuring the reflections. A measurement setting consists of the energy of the excitation of the ultrasonic vibration. Another measurement setting is the sensitivity of the measurement, which is due to a variable gain and a variable comparison value with which the amplified signal is compared. Already known methods for measuring a fill level by means of an ultrasonic signal use a plurality of consecutive measurements, wherein the sensitivity of the measurement (i.e. the gain is increased and/or the comparison value is reduced) is increased until an unambiguous signal for the fill level is found. In addition, the excitation energy of the ultrasonic vibration can also be varied. Alternatively, the measurement can start with a high sensitivity which then decreases from measurement to measurement, or any other search scheme with varying sensitivity.

According to the invention, a method and an apparatus are proposed, by means of which an improved evaluation of the measurement of the fill level of the fluid is carried out by evaluation of the propagation time of the acoustic signal in the tank 1. In particular, measurements made with different measurement settings are used jointly to determine the fill level.

FIG. 2 shows a voltage signal of the piezo element as a raw signal in the upper diagram 2A, an amplified signal derived from the latter and a comparison level in diagram 2B, and a digital signal determined in diagram 2C, in each case plotted against time.

In diagram 2A, an excitation signal of the piezo element 4 is displayed in a time window between T0 and T1. An oscillating voltage signal is applied to the piezo element by an external circuit, with a total of 6 oscillations occurring. By means of this external voltage, the piezo element 4 is stimulated into mechanical vibrations and thus generates an ultrasonic signal in the fluid 2 which passes through the fluid 2. The excitation energy of this ultrasonic signal can be changed by the level of the voltages or else by the number of vibrations. If higher voltages are applied to the piezo element, higher amplitudes of the deflection of the piezo element also result accordingly. Furthermore, the excitation energy can be increased by the number of vibrations. An excitation with 6 vibrations is shown in diagram 2A. To increase the energy of the excitation of the ultrasonic vibration, however, more vibrations can be introduced, which is particularly useful when the fill level is very high and the attenuation is correspondingly high.

In the time interval T1 to T2, a mechanical reverberation of the piezo element 4 occurs, wherein due to the piezo effect these mechanical vibrations generate corresponding voltages in the piezo element 4. These are significantly smaller than the vibrations of the excitation and therefore show significantly lower amplitudes in the raw signal of diagram 2A. However, no actual measurement can be carried out in this time range T1 to T2, since the actual measuring signal and the mechanical reverberation are superimposed. This time range is therefore suppressed for the evaluation. When the energy of the excitation of the ultrasonic vibration is increased, the intensity and the duration of the reverberations are also increased, with the result that the time interval T1 to T2 is extended. The duration of the suppression for the time interval T1 to T2 should therefore depend in particular on the excitation energy of the ultrasonic signal. Furthermore, it can also occur that the interval T1 to T2 is within the time interval in which the actual measurement signal, i.e. the reflected signal, is located. This can be the case, for example, if the fill level in the tank is particularly low and so the time interval between the excitation of the ultrasonic signal and the actual measurement signal is very small. In such a situation, it may be practical to reduce the excitation energy of the ultrasonic vibration in order to keep the time interval T1 to T2 very short to enable a measurement of the actual reflection signal to be made.

During the period between T2 and T3, the only voltages that occur at the piezo element 4 can be explained by noise due to the measuring device.

In the time interval T3 to T4, the sound wave reflected by the surface 3 reaches the piezo element 4 again and generates corresponding oscillations of the electrical voltage. As can be seen, this signal is significantly attenuated compared to the excitation in the time interval T0 to T1 and has an increasing amplitude envelope. The original vibrations of the excitation, which consisted of 6 vibrations of essentially equal size in the time interval T0 to T1, have been significantly attenuated and have an amplitude that increases from vibration to vibration, which then also decreases again. The intensities of this signal in the time interval T3 to T4 can be correspondingly increased by an increased energy of excitation of the ultrasonic vibration.

FIG. 2B shows a high-pass filtered and amplified signal, which was formed from the signal waveform of FIG. 2A. The time interval T0 to T1 was hidden for generating the signal waveform according to FIG. 2B. The mechanical reverberation of the piezo element in the time interval T1 to T2 and the reflected ultrasonic signal in the time interval T3 to T4 are very clearly visible. The signal of diagram 2B is compared with a comparison value 13, wherein this comparison value and the gain in FIG. 2B are selected such that the first reflection is reliably detected.

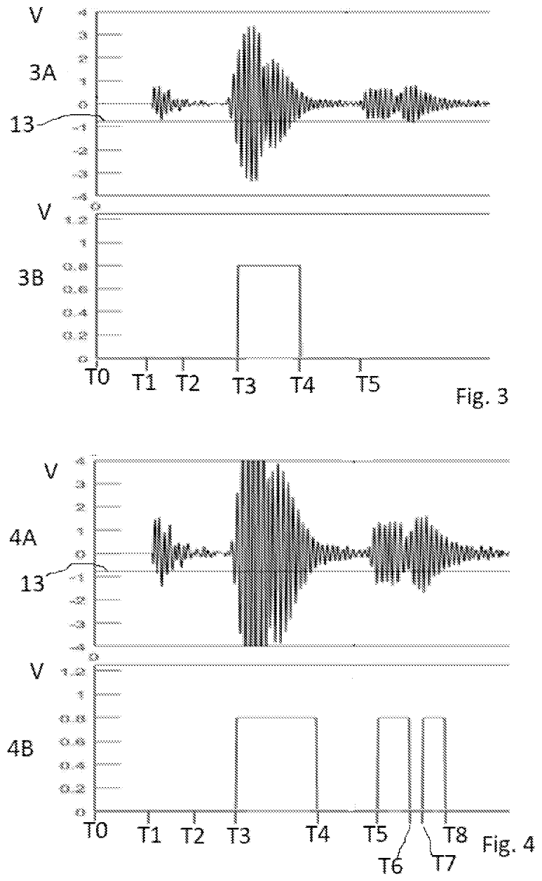

This signal of FIG. 2B is converted into a digital signal as shown in FIG. 2C. As can be seen, a comparison with the comparison value 13 produced the digital signal of FIG. 3C, which has a first state with a low voltage level in the time interval between T0 and T3, a second state with a high voltage level in the time range T3 to T4, and the low voltage level again in the time interval after T4. In order to generate the switching edges at time T3 and T4, both the overshooting of the comparison value 13 and a transition of the signal through the zero point are evaluated in the signal waveform of FIG. 2B. The rising edge at time T3 is triggered when the signal of FIG. 2B shows a sign change from negative to positive and the comparison value 13 has previously been exceeded (undershooting a negative value is also considered to be exceeding). The falling edge at time T4 is triggered when the signal of FIG. 2B shows a sign change from negative to positive and the comparison value 13 has not previously been exceeded. The digital signal of FIG. 2C can thus be determined from the signal waveform of FIG. 2B using simple means.

When generating the digital signal of FIG. 2C, even small errors in the signal acquisition can be corrected by means of an appropriate logic. In particular, very short interruptions of the digital signal can occur, for example, a 0 signal being displayed again for a very short time in the interval between times T3 and T4. This can occur if the comparison value 13 is exceeded or the zero crossing for a single oscillation has not been reliably detected. Such very short interruptions of the digital signal can be detected and corrected by means of an appropriate logic.

An evaluation with regard to the fill level is carried out on the basis of the digital signal of FIG. 2C. Since only one positive signal occurs in the waveform between the times T3 and T4, no definitive or correct fill level of the tank 1 can yet be derived from the waveform of FIG. 2C. Rather, it behaves in such a way that if only a single digital signal occurs, this is treated as a suspected first reflection, i.e. as a single emission of an acoustic signal from the piezo element 4 to the surface 3 and return of the signal reflected from the surface 3 back to the piezo element 4.

In order to confirm this suspected first reflection found in this way, it is logical to find a second reflection and to check the plausibility of these two reflections with each other. The propagation time of the second reflection must be twice as long as the propagation time of the first reflection within the limits of the measurement accuracy. This method will now be explained in more detail using the following FIGS. 3 and 4, using a variation of the gain as an example.

In FIG. 3A an amplified signal according to FIG. 2B is shown, wherein in contrast to FIG. 2B the gain has been increased. The corresponding voltage signal directly on the piezo element 4 has already been illustrated in FIG. 2A. The increased amplification of the signal according to FIG. 3A has an effect in particular on the digital signal of FIG. 3B derived from it. As can be seen, the time T3, i.e. the rising edge of the digital signal, has been shifted closer to the time T0. An increase in sensitivity thus caused a slightly earlier rising edge T3 and a slightly later falling edge T5 of the digital signal. To determine the fill level, the propagation time between the start of the excitation signal, i.e. the time T0, and the rising edge of the digital signal, i.e. the time T3, is typically evaluated. Due to an increasing sensitivity of the evaluation of the raw signal according to FIG. 2A, the propagation time is therefore able to be measured more precisely since an increase in the reflected signal can be detected more easily due to the increased gain. Alternatively, the comparison value could also be chosen lower, i.e. closer to the value 0. Both measures, increasing the gain and a sensitive comparison value, increase the sensitivity of the measurement and thus make it easier to detect a reflected signal. However, it is not always practical to choose a maximum value for the sensitivity, since as the sensitivity of the evaluation increases, the noise also has an increased effect on the digital signal. The optimally adjusted gain must be determined for each measured raw signal of the piezo element 4.

FIG. 4A shows an amplified signal of FIG. 2A again and FIG. 4B shows a digital signal derived from it. In comparison to FIG. 2B and FIG. 3A, a higher sensitivity has been chosen once again, in particular a further increased gain. This increased amplification of FIG. 4A now amplifies, in particular, the signals beyond the time T5 in such a way that the comparison value 13 is exceeded. In addition, the increased gain significantly increases the period of time between the rising edge at time T3 and the falling edge at time T4 compared to FIGS. 2C and 3B. Compared to FIGS. 2 and 3 therefore, the precision of the propagation time of the first reflection can be improved once again. Furthermore, from time T5 to T6 and from time T7 to T8, further digital signals in the waveform of FIG. 4B can be found, which are a second reflection or a completely different type of reflection, for example, due to reflections on a side wall of the tank or a strongly varying fluid surface 3. For this purpose, a plausibility check of the measurement is carried out by calculating the ratio of the propagation times. For this purpose, the rising edges T3, T5 and T7 are evaluated and examined for their relationship to each other. If it turns out that the time interval from T0 to T3 is half the length of the time interval from T0 to T5, then a first and a second reflection must be present. These data points are therefore plausible with respect to each other and can be used for calculating the fill level. The fill level can then be calculated both from the time interval T0 to T3 as well as from the time interval T0 to T5. The fill level then corresponds to the speed of sound multiplied by half the propagation time T0 to T3, or speed of sound multiplied by a quarter of the propagation time from T0 to T5.

The method according to the invention of FIGS. 3 and 4 therefore proposes that a plurality of successive measurements be performed and that the digital signals of measurements with different gain values that are found be taken into account simultaneously for the evaluations. For this purpose, successive measurements are made with an increasing sensitivity from measurement to measurement until a suspected first reflection is found. Further measurements with increased sensitivity are then carried out until a suspected second reflection is found. If a suspected first and a suspected second reflection are found, they are checked against each other for plausibility based on the respective propagation times. If this plausibility check is successful, the fill level of the tank is calculated from it. The two reflections are plausible with respect to each other if the propagation time of the second reflection is twice as long as the propagation time of the first reflection within the limits of a specified measurement accuracy. If this is not the case, or if further digital signals are found between the suspected first reflection and the suspected second reflection, the measurements are evaluated as implausible and no fill level is calculated from them.

As an alternative to changing the gain, the other measurement settings such as the comparison value 13 used or the energy of excitation of the ultrasonic signal, can of course also be used. In this alternative method, the comparison value 13 is varied from measurement to measurement, or else the excitation energy of the ultrasound signal.

If a suspected first and second reflection are found using the measurements with different sensitivity, but these are reversed due to their propagation times, the role of the first and second reflections can also be reversed. These reversed reflections can then be used to calculate the fill level.

As is apparent from consideration of the increasing width of the digital signal between T3 and T4 in FIGS. 2, 3 and 4, the width of the digital signal of the first reflection increases with increasing gain. From the width of the digital signal of the first reflection it is therefore possible to derive an estimate of the amplification required for the reliable detection of the second reflection. For example, if the first suspected reflection found is very narrow, as shown in FIG. 2C, the higher gain of FIG. 4 can be used immediately for the next measurement, and not the lower gain of FIG. 3.

The previous description assumed, by way of example, that the measurements with different sensitivity are carried out one after the other. However, if a plurality of circuits are available for the evaluation of the raw signal according to FIG. 2A, a plurality of signal waveforms amplified with different gains according to FIGS. 2, 3 and 4 can be measured simultaneously. The digital signals determined in this way can then be processed simultaneously. However, this requires an appropriately equipped processing electronics, with multiple gain levels and multiple comparison levels.

Furthermore, it has already been stated that in particular the rising edge at time T3 or T5 is used to determine the propagation time. In an alternative embodiment, it is also possible to increase the sensitivity as soon as a first rising edge is found at time T3. The measurement of a rising edge T5 occurring later on would then be carried out with an increased sensitivity anyway. In this way, several measurements with different measurement sensitivities can be implemented with a single operation. This naturally presupposes an appropriately adapted evaluation circuit, which allows a corresponding switching of the sensitivity while the measurement is running.

In a further embodiment, after time T2 a period is defined in which the digital signal must not assume the high level. If a high voltage level of the digital signal is measured during this period, the measurement is rejected as invalid. This can prevent false fill level outputs, which can be caused by the first reflection being associated with the reverberation (i.e. no rising edge T3 of the digital signal is detected) and the second reflection being incorrectly interpreted as the first.

1. A method for determining the fill level of a fluid (2) in a tank (1), wherein a propagation time of an ultrasonic signal between an ultrasound element (4) and a reflection at the surface (3) of the fluid (2) is measured, wherein a first, single reflection and a second, double reflection are evaluated, wherein the measurement of the reflections is carried out with a measurement setting with an excitation energy of the ultrasonic signal and a sensitivity, the sensitivity being indicated by a gain and a comparison value (13), wherein via measurements with different measurement settings a suspected first reflection and a suspected second reflection are found, and that a plausibility check is carried out of the propagation times of the first and second reflections relative to each other.

2. The method according to claim 1, wherein, with successive measurements with a measurement setting changed from measurement to measurement, a suspected first reflection is found and then with a measurement setting modified again, a suspected second reflection is found, and the plausibility check is then carried out of the propagation times of the first and second reflections relative to each other.

3. The method according to claim 1, wherein if the propagation time of the suspected second reflection within a given measurement accuracy is twice as long as the propagation time of the suspected first reflection, the plausibility check indicates a correct measurement, and that a fill level is calculated in the event of a correct measurement.

4. The method according to claim 1, wherein the plausibility check indicates an incorrect measurement if the propagation time of the second reflection within a given measurement accuracy is not twice as long as the propagation time of the first reflection, or if a further reflection is found between the first and second reflection.

5. The method according to claim 1, wherein if the propagation time of the suspected second reflection within a given measurement accuracy is half as long as the propagation time of the suspected first reflection, the plausibility check indicates a correct measurement in which the role of the first and second reflection is reversed, and that a fill level is calculated in the event of a correct measurement.

6. The method according to claim 1, wherein a digital signal is formed for the measurement of the reflections, in which a digital level assumes a first state if the amplified ultrasonic signal has a predetermined path, preceded by an overshooting of the threshold value (13) and the digital level assumes a second state if the amplified ultrasonic signal has a predetermined path without a preceding overshooting of the threshold value (13).

7. The method according to claim 6, wherein from a temporal length of the digital signal of the suspected first reflection, an increase in the sensitivity for locating the suspected second reflection is determined.

8. The method according to claim 1, wherein a plurality of sensitivities for locating the first and second reflection are evaluated simultaneously.

9. The method according to claim 1, wherein in a measurement, as soon as the first reflection has been found, the sensitivity is increased for the remainder of the measurement in order to find the suspected second reflection.

10. Apparatus for determining the fill level of a fluid (2) in a tank (1), having means for measuring a propagation time of an ultrasonic signal between an ultrasound element (4) and a reflection at the surface (3) of the fluid (2), and for evaluating a first, single reflection and a second, double reflection, wherein the measurement of the reflections is carried out with a measurement setting with an excitation energy of the ultrasonic signal and a sensitivity, the sensitivity being indicated by a gain and a comparison value (13), wherein via measurements with different measurement settings the means locate a suspected first reflection and a suspected second reflection, and perform a plausibility check of the propagation times of the first and second reflections relative to each other.
